(19) United States
(12) Patent Application Publication
(10) Pub. No.: US 2024/0271023 A1
(43) Pub. Date: Aug. 15, 2024

(54) TWO-COMPONENT POLYURETHANE ADHESIVE COMPOSITION

(71) Applicant: DDP SPECIALTY ELECTRONIC MATERIALS US, LLC, WILMINGTON, DE (US)

(72) Inventors: ANDREAS LUTZ, Galgenen (CH); DANIEL SCHNEIDER, FREIENBACH (CH)

(21) Appl. No.: 18/569,339

(22) PCT Filed: Jun. 3, 2022
(86) PCT No.: PCT/US22/32098

§ 371 Date: Dec. 12, 2023

Related U.S. Application Data
(60) Provisional application No. 63/238,428, filed on Aug. 30, 2021.

(51) Int. Cl. C09J 175/08; C08G 18/10; C08G 18/16; C08G 18/18; C08G 18/22; C08G 18/34; C08G 18/48; C08G 18/66; C08G 18/73; C09J 11/04

(52) U.S. Cl. CPC C09J 175/08; C08G 18/10; C08G 18/163; C08G 18/1833; C08G 18/227; C08G 18/34; C08G 18/4825; C08G 18/6692; C08G 18/73; C09J 11/04

(57) ABSTRACT

Provided herein is a two-component polyurethane adhesive composition.

### FIELD OF INVENTION

The present invention relates to the field of two-component polyurethane adhesive compositions.

### BACKGROUND OF THE INVENTION

Two component polyurethane (PU) adhesives or sealants are widely used in the automotive industry in repair or in the assembly shop to bond painted or e coated metal panels, painted or surface treated plastics or composites. The commonly used adhesive or sealant chemistry in the market today is isocyanate-containing polyurethane technologies.

Conventional two-component PU adhesives consist of an A Part comprising PU polymers terminated with isocyanate groups (blocked or unblocked), and a B Part comprising polyamines. In use, Parts A and B are mixed, which starts curing through reaction of the amine groups with the isocyanate groups.

A disadvantage of such adhesives is that they comprise residual diisocyanate monomers that are considered to be toxic. New regulations require that the residual diisocyanate content be below 0.1%, otherwise the user needs to be trained specifically (https://echa.europa.eu/registry-of-restriction-intentions/-/dislist/details/0b0236e180876053).

One way to reduce the monomeric diisocyanate content is to remove the excess monomers by distillation, however, this process is expensive, time- and energy-consuming and therefore not preferred. It would be preferable to formulate the 2K PU adhesives in absence of isocyanates to remove the potential risks.

### SUMMARY OF THE INVENTION

In a first aspect, the invention provides a two-component polyurethane adhesive composition comprising:
(A) Component A comprising a polyurethane prepolymer made by reacting at least one polyisocyanate and at least one polyol (resulting in Intermediate I), followed by reaction with a molecule of Formula I:

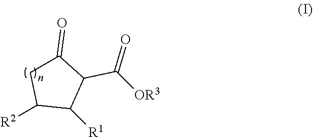

where R¹ and R² are independently selected from hydrogen and C₁ to C₆ alkyl, n is an integer from 1 to 2, and R³ is C₁ to C₆ alkyl;
and optionally a catalyst capable of catalyzing the reaction of an amine with the moiety resulting from the molecule of Formula I, and optionally CaO; AND
(B) Component B comprising a polyamine, and optionally a catalyst capable of catalyzing the reaction of an amine with the moiety resulting from the molecule of Formula I, and optionally CaO;
wherein at least one of Component A and Component B comprises the catalyst capable of catalyzing the reaction of an amine with the moiety resulting from the molecule of Formula I, and at least one of Component A and Component B comprises CaO.

In a second aspect, the invention provides a two-component polyurethane adhesive composition comprising:
(A) Component A comprising a polyurethane prepolymer made by reacting at least one polyisocyanate and at least one polyol (resulting in Intermediate I), followed by reaction with a molecule of Formula I:

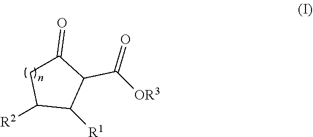

where R¹ and R² are independently selected from hydrogen and C₁ to C₆ alkyl, n is an integer from 1 to 2, and R³ is C₁ to C₆ alkyl;
and optionally a catalyst capable of catalyzing the reaction of an amine with the moiety resulting from the molecule of Formula I, and optionally CaO, and optionally at least one phenolic antioxidant; AND
(B) Component B comprising a polyamine, and optionally a catalyst capable of catalyzing the reaction of an amine with the moiety resulting from the molecule of Formula I, and optionally CaO, and optionally at least one phenolic antioxidant;
wherein at least one of Component A and Component B comprises the catalyst capable of catalyzing the reaction of an amine with the moiety resulting from the molecule of Formula I, at least one of Component A and Component B comprises CaO, and at least one of Component A and B comprises at least one phenolic antioxidant.

In a third aspect, the invention provides a method for adhering a first substrate and a second substrate, comprising the steps:
(1) mixing the Components A and B of an adhesive composition of the invention to obtain a mixture;
(2) applying the mixture to the first substrate, the second substrate or both;
(3) bringing the first substrate and the second substrate into adhesive contact;
(4) allowing the mixture to cure.

In a fourth aspect, the invention provides an adhered assembly comprising:
(1) a first substrate;
(2) a second substrate;
(3) an adhesive composition according to the invention obtained by mixing Component A and Component B;
wherein the first and second substrates are in adhesive contact with the adhesive composition sandwiched between them.

### DETAILED DESCRIPTION OF THE INVENTION

The inventors have found that the inclusion of calcium oxide and optionally a phenolic antioxidant results in two-component polyurethane adhesives having improved heat and weathering resistance.

### Definitions and Abbreviations

MDI 4,4′-Methylenebis(phenyl isocyanate)
HDI Hexamethylene diisocyanate
IPDI isophorone diisocyanate
PU polyurethane
SEC size exclusion chromatography
RH relative humidity

Equivalent and molecular weights are measured by gel permeation chromatography (GPC) with a Malvern Viscothek GPC max equipment. Tetrahydrofuran (THF) was used as an eluent, PL GEL MIXED D (Agilent, 300*7.5 mm, 5 μm) was used as a column, and MALVERN Viscotek TDA (integrated refractive index viscometer and light scattering) was used as a detector.

### Component A

Component A comprises a polyurethane prepolymer made by reacting at least one polyisocyanate and at least one polyol (resulting in Intermediate I), followed by reaction with a molecule of Formula I.

### Polyisocyanate and Polyol

The inventive compositions comprise a polyurethane prepolymer made by reacting at least one polyisocyanate and at least one polyol (resulting in Intermediate I), followed by reaction with at least one molecule of Formula I, in an amount to react all NCO groups.

The at least one polyol is preferably selected from polyether polyols, polyester polyols (e.g. polycaprolactone), polybutadiene diols, polycarbonate diols, aliphatic diols (polyols), and mixtures of any of these. Polyether polyols are particularly preferred.

The at least one polyol is preferably a diol, triol or tetra-ol. Preferably it is a triols or a mixture of a triol and a diol, with triols being particularly preferred.

Polyether polyols useful in the invention include for example, polyether polyols, poly(alkylene carbonate)polyols, hydroxyl containing polythioethers, polymer polyols, and mixtures thereof. Polyether polyols are well-known in the art and include, for example, polyoxyethylene, polyoxypropylene, polyoxybutylene, and polytetramethylene ether diols and triols which may be prepared, for example, by reacting an unsubstituted or halogen- or aromatic-substituted ethylene oxide or propylene oxide with an initiator compound containing two or more active hydrogen groups such as water, ammonia, a polyalcohol, or an amine. In general, polyether polyols may be prepared by polymerizing alkylene oxides in the presence of an active hydrogen-containing initiator compound. Preferred polyether polyols contain one or more alkylene oxide units in the backbone of the polyol. Preferred alkylene oxide units are ethylene oxide, propylene oxide, butylene oxide and mixtures thereof. Preferably, the polyol contains propylene oxide units, ethylene oxide units or a mixture thereof. In the embodiment where a mixture of alkylene oxide units is contained in a polyol, the different units can be randomly arranged or can be arranged in blocks of each alkylene oxides. In one preferred embodiment, the polyol comprises propylene oxide chains. In a preferred embodiment, the polyether polyols are a mixture of polyether diols and polyether triols. Preferably, the polyether polyol or mixture has a functionality of at least about 2.0; and is preferably about 3.0 or greater, for example, 3.5, 4.0 or greater. Preferably, the equivalent weight of the polyether polyol mixture is at least about 200 Da, more preferably at least about 500 Da, and is more preferably at least about 1,000 Da; and is preferably no greater than about 5,000 Da, more preferably no greater than about 3,000 Da.

More specific examples of polyether polyols include:
1. Difunctional polyols (diols), such as poly(alkylene oxide)diols, where the alkylene group is C₂ to C₄, particularly poly(ethylene oxide)diol, poly(propylene oxide)diol, poly(butylene oxide) diol and poly(tetramethylene oxide)diol, with poly(propylene oxide)diol being particularly preferred. In a particularly preferred embodiment the polyether polyol comprises a nominally difunctional, poly(propylene oxide) having an equivalent weight of from 100 to 10,000, more preferably 500 to 3,000, particularly preferably 1,000 to 2,000;
2. Trifunctional polyols (triols), such as those based on the alkylene oxides initiated with a trifunctional polyol, such as trimethylolpropane, where the alkylene group is C₂ to C₄, particularly ethylene oxide, propylene oxide, butylene oxide, tetramethylene oxide and butylene oxide, with propylene oxide being particularly preferred. In a particularly preferred embodiment, the polyether polyol comprises a nominally trifunctional poly(propylene oxide) having an equivalent weight of from 100 to 10,000, more preferably 500 to 3,000, particularly preferably 1,000 to 2,000; the polymer may or may not be capped with ethylene oxide to modify reactivity.
3. A mixture of 1 and 2. Particularly preferred is a mixture of 1 and 2, more particularly preferred is a mixture of a) a nominally difunctional, poly(propylene oxide) having an equivalent weight of from 100 to 10,000, more preferably 500 to 3,000, particularly preferably 1,000 to 2,000 and b) a nominally trifunctional poly(propylene oxide) and equivalent weight of 1,000 to 2,000, particularly at a weight ratio b)/a) of 0:1-2:1.

In a particularly preferred embodiment, the at least one polyol comprises a propylene oxide based diol or triol. Preferably the polypropylene oxide based diol or triol has a molecular weight of from 1,000 to 5,000 Da, more preferably 1,000 to 3,000 Da.

Polyester polyols include any hydroxyl terminated polyesters. Particularly preferred are hydroxyl terminated aliphatic polyesters and polycaprolactone. Polyester diols and triols are preferred, particular polyester triols. Particularly preferred are copolyesters having molecular weight of 2,000-4,000 Da, preferably 3,500 Da.

The polyisocyanate that may be used to make Intermediate I is not particularly limited. Preferred are diisocyanates.

Aliphatic and aromatic diisocyanates may be used, with aliphatic being preferred. Examples of suitable diisocyanates include toluene diisocyanate (TDI), hexamethylene diisocyanate (HDI), naphthalene diisocyanate (NDI), methylene bis-cyclohexylisocyanate (HMDI) (hydrogenated MDI), MDI (in particular 4,4′- and 4,2-MDI) and isophorone diisocyanate (IPDI), with HDI being particularly preferred.

In a preferred embodiment, Intermediate I is made by reacting a polyether triol with HDI. In a particularly preferred embodiment it is made by reacting a polypropylene oxide based triol with HDI. In a more particularly preferred embodiment it is made by reacting a polypropylene oxide based triol of molecular weight 4,800 with HDI.

In a preferred embodiment, Intermediate I is made by reacting an aliphatic polyester of molecular weight 3,500 with MDI. In a particularly preferred embodiment, the polyester prepolymer is made be reacting 65 to 80 wt % polyester diol with 5 to 15 wt % MDI.

Intermediate I may comprise a mixture of a polyether polyol-based prepolymer and a polyester-based prepolymer.

In a particularly preferred embodiment, Intermediate I is based on a polyether diol and a polyether triol.

The diisocyanate that may be used to make Intermediate I is not particularly limited. Aliphatic and aromatic diisocyanates may be used. Examples of suitable diisocyanates include toluene diisocyanate (TDI), hexamethylene diisocyanate (HDI), naphthalene diisocyanate (NDI), methylene bis-cyclohexylisocyanate (HMDI) (hydrogenated MDI), MDI (in particular 4,4′- and 4,2-MDI) and isophorone diisocyanate (IPDI), with HDI being particularly preferred.

In a particularly preferred embodiment, Intermediate I comprises a nominally trifunctional poly(propylene oxide) and a nominally trifunctional poly(propylene oxide), reacted with MDI or HDI.

In a particularly preferred embodiment, Intermediate I comprises a nominally trifunctional poly(propylene oxide) having a hydroxyl number of 56 (equivalent weight 1000) and a nominally trifunctional poly(propylene oxide) having a hydroxyl number of 36 (equivalent weight 1558), reacted with MDI or HDI.

Intermediate I is made by reacting the at least one polyol with the polyisocyanate, using a catalyst capable of catalyzing the reaction of an NCO group with a hydroxyl group. Preferred catalysts are mentioned below.

Polymerisation may be carried out in the presence of a plasticizer, such as a high boiling ester or diester, for example diisononyl phthalate. Diisononyl phthalate is particularly preferred.

In a preferred embodiment, Intermediate I comprises 18 to 30 wt % polyol diol, more preferably 19 to 25 wt %, more particularly preferably 22 to 23 wt %, based on the total weight of Intermediate I.

In a preferred embodiment, Intermediate I comprises 40 to 90 wt % polyol triol, 50 to 90 wt %, more particularly preferably 75 to 85 wt %, based on the total weight of Intermediate I.

In a preferred embodiment, Intermediate I comprises 5 to 15 wt % diisocyanate, more preferably 8 to 12 wt %, more particularly preferably 8 to 10 wt %, based on the total weight of Intermediate I.

In a particularly preferred embodiment, Intermediate I comprises 22 to 23 wt % polyol diol, 32 to 33 wt % polyol triol, and 9 to 11 wt % diisocyanate, based on the total weight of Intermediate I.

In a preferred embodiment, Intermediate I comprises 18 to 30 wt % of a nominally difunctional, poly(propylene oxide) having a hydroxyl number of 56 (equivalent weight 1000), more preferably 19 to 25 wt %, more particularly preferably 22 to 23 wt %, based on the total weight of Intermediate I.

In a preferred embodiment, Intermediate I comprises 25 to 40 wt % of a nominally trifunctional poly(propylene oxide) having a hydroxyl number of 36 (equivalent weight 1558), 28 to 35 wt %, more particularly preferably 32 to 33 wt %, based on the total weight of Intermediate I.

In a preferred embodiment, Intermediate I comprises 5 to 15 wt % MDI or HDI, more preferably 8 to 12 wt %, more particularly preferably 9 to 11 wt %, based on the total weight of Intermediate I.

In a particularly preferred embodiment, Intermediate I comprises 22 to 23 wt % of a nominally difunctional, poly(propylene oxide) having a hydroxyl number of 56 (equivalent weight 1000), 32 to 33 wt % of a nominally trifunctional poly(propylene oxide) having a hydroxyl number of 36 (equivalent weight 1558), and 9 to 11 wt % MDI, based on the total weight of Intermediate I.

In a particularly preferred embodiment, Intermediate I comprises 22 to 23 wt % of a nominally difunctional, poly(propylene oxide) having a hydroxyl number of 56 (equivalent weight 1000), 32 to 33 wt % of a nominally trifunctional poly(propylene oxide) having a hydroxyl number of 36 (equivalent weight 1558), and 9 to 11 wt % MDI, based on the total weight of Intermediate I, and has an isocyanate content of 1.25% by weight, and a viscosity of 16,000 cps at 23° C. as measured according to the procedure described in U.S. Pat. No. 5,922,809 at column 12, lines 38 to 49.

### End Group (Molecule of Formula I)

The prepolymer is made by reacting the at least one polyisocyanate with the at least one polyol (resulting in Intermediate I), followed by reaction with a molecule of Formula I:

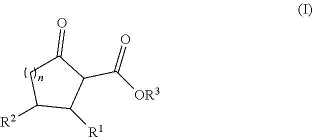

where R¹ and R² are independently selected from hydrogen and C₁ to C₆ alkyl, n is an integer from 1 to 2, and R³ is C₁ to C₆ alkyl;
Preferably R¹ and R² are independently selected from H and C₁ to C₄ alkyl, more preferably H and C₁ to C₂ alkyl, particularly preferably R¹ and R² are H.

Preferably n is 1.

Preferably R³ is C₁ to C₄ alkyl, more preferably R³ is C₁ to C₂ alkyl, particularly preferably R³ is ethyl.

In a particularly preferred embodiment, in the molecule of Formula I, R¹ and R² are H, n is 1, and R³ is ethyl [2-(ethoxycarbonyl)cyclopentanone, CPEE].

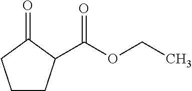

The molecule of Formula I reacts with the NCO groups of Intermediate I. It is preferably used in an amount that will react with all NCO groups of the Intermediate I, meaning at least an amount that is equivalent to the free NCO groups of Intermediate I, or an excess, for example 1, 1.1 or 1.2 equivalents.

In order to reduce or eliminate any monomeric diisocyanate in Intermediate I, the amount or molecule of Formula I that is added is calculated to react not only with the NCO groups of Intermediate I, but also with any residual monomeric diisocyanate. This essentially eliminates all NCO groups, both in the prepolymer and free monomeric diisocyanate, leading to an NCO content of less than 0.1 wt %, preferably essentially 0.

### Catalyst for Polyurethane Prepolymer

Intermediate I is made by reacting the at least one polyisocyanate with the at least one polyol in the presence of a catalyst capable for catalysing the reaction of an NCO functionality with an OH functionality.

Examples of such catalysts include tertiary amine catalysts, bismuth catalysts alkyl tin carboxylates, oxides and mercaptides. Specific examples include triethylenediamine, 1,4-diazabicyclo[2.2.2]octane, dimethylcyclohexylamine, dimethylethanolamine, and bis-(2-dimethylaminoethyl)ether, bismuth catalysts, dibutyltin dilaurate, stannous octoate, with bismuth catalysts being particularly preferred.

For reaction with the molecule of Formula I, a zinc catalyst, in particular a zinc carboxylate catalyst is preferred. In a preferred embodiment, a mixture of zinc and bismuth carboxylates is used.

If an organometallic catalyst is used, it is any organometallic catalyst capable of catalyzing the reaction of isocyanate with a functional group having at least one reactive hydrogen. Examples include bismuth catalysts, metal carboxylates such as tin carboxylate and zinc carboxylate. Metal alkanoates include stannous octoate, bismuth octoate or bismuth neodecanoate. Preferably the at least one organometallic catalyst is a bismuth catalyst or an organotin catalyst. Examples include dibutyltin dilaurate, dimethyl tin dineodecanoate, dimethyltin mercaptide, dimethyltin carboxylate, dimethyltin dioleate, dimethyltin dithioglycolate, dibutyltin mercaptide, dibutyltin bis(2-ethylhexyl thioglycolate), dibutyltin sulfide, dioctyltin dithioglycolate, dioctyltin mercaptide, dioctyltin dioctoate, dioctyltin dineodecanoate, dioctyltin dilaurate. In a particularly preferred embodiment, it is a bismuth catalyst.

The catalyst is preferably used at 0.05 to 2 wt %, more preferably 0.1 to 1 wt %, based on the total weight of the adhesive composition.

In a preferred embodiment, the catalyst is a zinc and bismuth catalyst, used at 0.05 to 0.3 wt % based on the total weight of the adhesive composition.

### Polyurethane Prepolymer

The polyurethane prepolymer resulting from reaction of Intermediate I and the molecule of Formula I, as detailed above, and any combination of polyol, polyisocyanate and molecule of Formula I is contemplated herein.

In a preferred embodiment, the polyurethane prepolymer comprises a polypropylene oxide-based diol with MWT of 2,000 Da, 1,6-HDI and CPEE.

In a particularly preferred embodiment, the polyurethane prepolymer comprises 70-90 wt % of a polypropyleneoxide-based diol with a MWT of 2,000 g/mol, 5-15 wt % 1,6-HDI, and 5-15 wt % CPEE.

In a particularly preferred embodiment, the polyurethane prepolymer comprises 74.57 wt % of a polypropyleneoxide-based diol with a MW of 2,000 g/mol, 12.57 wt % 1,6-HDI, and 12.36 wt % CPEE.

The polyurethane prepolymer is preferably present in Component A of the adhesive at 40-80 wt %, more preferably 45-75 wt %, more particularly preferably 55 to 70 wt % based on the total weight of Component A.

In a particularly preferred embodiment, Component A of the adhesive composition of the invention comprises 40-80 wt %, more preferably 45-75 wt %, more particularly preferably 55 to 70 wt % based on the total weight of Component A, of a polyurethane prepolymer comprising a nominally difunctional poly(propylene oxide) and a nominally trifunctional poly(propylene oxide) reacted with MDI, followed by reaction with a molecule of Formula I.

Preferably, the prepolymer or prepolymer mixture has a viscosity of at least 6,000 centipoise or at least about 8,000 centipoise, and as much as 30,000 centipoise or as much as 20,000 centipoise. If the viscosity is too high, it will be difficult to pump the final adhesive composition. If the viscosity is too low, the final adhesive composition will be too runny and/or will sag.

Prepolymer equivalent and molecular weights are measured by gel permeation chromatography (GPC) with a Malvern Viscothek GPC max equipment. Tetrahydrofuran (THF) was used as an eluent, PL GEL MIXED D (Agilent, 300*7.5 mm, 5 μm) was used as a column, and MALVERN Viscotek TDA (integrated refractive index viscometer and light scattering) was used as a detector.

The polyurethane prepolymer has an isocyanate content of less than 0.1 wt %, more preferably 0% by weight.

In another preferred embodiment the polyurethane prepolymer has an isocyanate content of less than 0.1 wt %, more preferably 0% by weight, and a viscosity of 16,000 cps at 23° C. as measured according to the procedure described in U.S. Pat. No. 5,922,809 at column 12, lines 38 to 49.

In a preferred embodiment, Component A comprises:
at least one polyurethane prepolymer as described herein; and
CaO.

In a preferred embodiment, Component A comprises:
at least one polyurethane prepolymer as described herein; and
aluminium oxide.

In a preferred embodiment, Component A comprises:
at least one polyurethane prepolymer as described herein;
aluminium oxide; and
CaO.

### Component B

Component B comprises a polyamine, and optionally a catalyst capable of catalyzing the reaction of an amine with the moiety resulting from the molecule of Formula I.

### Polyamine

Component B comprises at least one polyamine, preferably a diamine or triamine, or a mixture of these.

Preferable the polyamine has a molecular weight of at least 400 Da, more preferably at least 1,000 Da, more particularly preferably at least 2,000 Da. In a preferred embodiment, the polyamine has a molecular weight of 2,000-4,000 Da, more preferably about 3,000 Da.

Preferably the amine groups are primary or secondary amine groups, particularly preferably primary amine groups.

In a preferred embodiment, the polyamine is a diamine, triamine or mixture of these, wherein the diamine or triamine has a molecular weight of 2,000-4,000 Da.

In another preferred embodiment, the polyamine is a triamine having primary amine groups and having a molecular weight of 2,000-4,000 Da, more preferably 3,000 Da.

Examples of suitable compounds having primary and/or secondary amino groups include polyoxyalkylene polyamines having 2 or more amine groups per polyamine, 2 to 4 amine groups per polyamine, or 2 to 3 amine groups per polyamine. Particularly preferred are polyether amines having 3 amine groups.

The polyoxyalkylene poly-amines may have a weight average molecular weight of at least 400 Da, more preferably at least 1,000 Da, more particularly preferably at least 2,000 Da. In a preferred embodiment, the polyoxyalkylene polyamine has a molecular weight of 2,000-4,000 Da, more preferably about 3,000 Da. The polyoxyalkylene polyamine may have a weight average molecular weight of about 5,000 or less or about 3,000 or less.

Exemplary polyoxyalkylene polyamines include:
1. Polyamines based on a propylene oxide polyether backbone. Examples include:

A trifunctional primary amine having an average molecular weight of approximately 440. Its amine groups are located on secondary carbon atoms at the ends of aliphatic polyether chains:

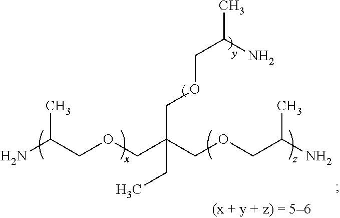

A polypropylene oxide diamine having a molecular weight of about 400:

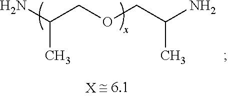

A difunctional, primary amine with average molecular weight of about 2000. The primary amine groups are located on secondary carbon atoms at the end of the aliphatic polyether chains:

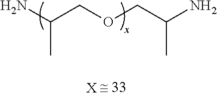

A triamine of approximately 3000 molecular weight, of the formula:

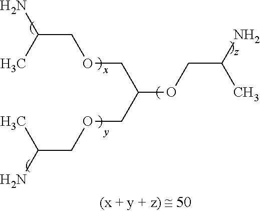

A triamine of approximately 5,000 g/mol, of the formula:

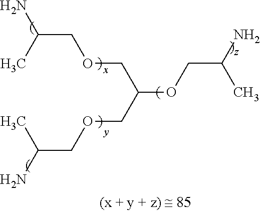

2. Polyamines based predominantly on a polyethylene oxide polyether backbone. Examples are of the general formula:

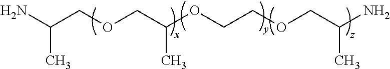

Such as a polyamine of molecular weight 600 g/mol, where y≈9, (x+z)≈3.6;

A polyamine of molecular weight of 900 g/mol, where y≈12.5, (x+z)≈6;

A polyamine of molecular weight 2,000 g/mol, where y≈39, (x+z)≈6;

In a particularly preferred embodiment the at least one polyamine comprises or consists of a triamine of approximately 3000 molecular weight, of the formula:

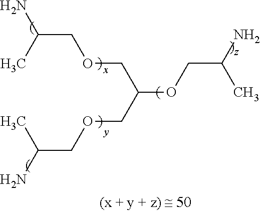

Other suitable polyamines include polyamidoamines, which comprise repetitively branched subunits of amide and amine functionality. For example, suitable polyamidoamines are initiated with ammonia or ethylene diamine, reacted by Michael addition with an acrylate ester (for example methyl acrylate), followed by reaction of the ester functionalities with a diamine (such as ethylene diamine). This results in a primary amine terminated polyamine, which may be again reacted by Michael addition, followed by reaction again with a diamine. The first “cycle” is represented schematically below using ethylene diamine and methyl acrylate:

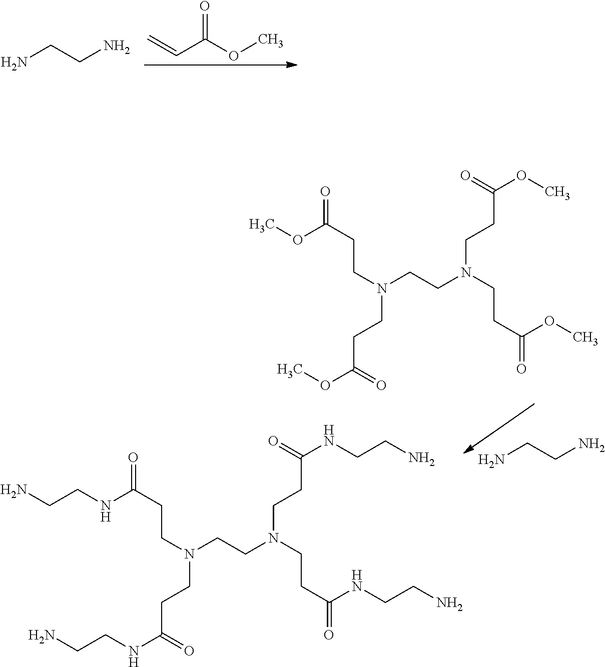

Other suitable polyamines include phenalkamines, which are made by a Mannich reaction between cardanol, formaldehyde and at least one polyamine.

In a preferred embodiment, Component B comprises the following ingredients:
at least one polyamine; and
a catalyst capable of catalysing the reaction of an amine with the moiety resulting from the molecule of Formula I.

In another preferred embodiment, Component B comprises the following ingredients:
at least one polyamine;
a catalyst capable of catalysing the reaction of an amine with the moiety resulting from the molecule of Formula I; and
CaO.

In another preferred embodiment, Component B comprises the following ingredients:
at least one polyamine;
a catalyst capable of catalysing the reaction of an amine with the moiety resulting from the molecule of Formula I;
CaO; and
at least one phenolic antioxidant.

### Calcium Oxide

Component A and/or Component B comprises calcium oxide (CaO).

CaO is preferably present in the final mixture resulting from mixing of Component A and Component B at a concentration of from 2 to 6 wt %, more preferably 3 to 5 wt %, particularly preferably about 3.5 wt %, based on the total weight of the mixture of Component A and Component B.

The concentrations mentioned above can be achieved by having CaO present in one or both of Components A and B. The concentration of CaO to use in any one of Components A and B can be calculated from the mixing ratio of A:B and the desired final concentration in the mixed adhesive.

In a preferred embodiment, CaO is present in Component A at 3 to 6 wt %, more preferably 5 wt %, based on the total weight of Component A, and CaO is present in Component B at 1 to 3 wt %, more preferably 2 wt %, based on the total weight of Component B, such that when Components A and B are mixed in a 1:1 ratio, the concentration of CaO in the final mixed adhesive is 2 to 4.5 wt %, more preferably 3.5 wt %, based on the total weight of the mixed adhesive.

In a preferred embodiment, the invention provides a two-component polyurethane adhesive composition comprising:
(A) Component A comprising a polyurethane prepolymer made by reacting at least one polyisocyanate and at least one polyol (resulting in Intermediate I), followed by reaction with a molecule of Formula I:

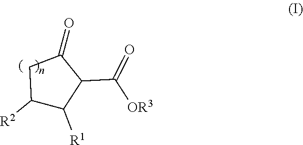

where R¹ and R² are independently selected from hydrogen and C₁ to C₆ alkyl, n is an integer from 1 to 2, and R³ is C₁ to C₆ alkyl;
and optionally a catalyst capable of catalyzing the reaction of an amine with the moiety resulting from the molecule of Formula I, and optionally CaO; AND
(B) Component B comprising a polyamine, and optionally a catalyst capable of catalyzing the reaction of an amine with the moiety resulting from the molecule of Formula I, and optionally CaO;
wherein at least one of Component A and Component B comprises the catalyst capable of catalyzing the reaction of an amine with the moiety resulting from the molecule of Formula I, and at least one of Component A and Component B comprises CaO. Preferably the two-component polyurethane adhesive composition has an NCO content of less than 0.1 wt % as determined according to ASTM D2572-97.

### Antioxidant

Component A and/or Component B comprises at least one antioxidant, in particular at least one phenolic antioxidant, preferably a hindered phenol antioxidant.

Typical examples include: 4,6-bis(octylthiomethyl)-o-cresol (Irganox 1520L), pentaerythritol tetrakis[3-[3,5-di-tert-butyl-4-hydroxyphenyl]propionate (Irganox 1010), octadecyl-3-[3,5-di-tert-butyl-4-hydroxyphenyl]propionate] (Irganox 1076), N,N′-hexane-1,6-diylbis(3-(3,5-di-tert-butyl-4-hydroxyphenylpropionamide)) (Irganox 1098), 3,3′,3′,5,5′,5′-hexa-tert-butyl-a,a′,a′-(mesitylene-2,4,6-triyl)tri-p-cresol (Irganox 1330), 1,3,5-tris(3,5-di-tert-butyl-4-hydroxybenzyl)-1,3,5-triazine-2,4,6(1H,3H,5H)-trione (Irganox 3114), ethylene bis (oxyethylene) bis-(3-(5-tert-butyl-4-hydroxy-m-tolyl)-propionate) (Irganox 245), benzenepropanoic acid, 3,5-bis (1,1-dimethyl-ethyl)-4-hydroxy-C₇-C₉ branched alkyl esters (Irganox 1135), 3,5-Di-tert-butyl-4-hydroxcinnamic acid (Irganox 3125), hexamethylene bis(3-(3,5-di-tert.-butyl-4-hydroxyphenyl)propionate) (Irganox 259), Thiodiethylene bis[3-(3,5-di-tert.-butyl-4-hydroxy-phenyl)propionate] (Irganox 1035).

4,6-bis(octylthiomethyl)-o-cresol (Irganox 1520L) is particularly preferred.

The at least one phenolic antioxidant is preferably present in the final mixture resulting from mixing of Component A and Component B at a concentration of from 0.5 to 6 wt %, more preferably 1 to 3 wt %, particularly preferably about 2 wt %, based on the total weight of the mixture of Component A and Component B.

The concentrations mentioned above can be achieved by having the at least one phenolic antioxidant present in one or both of Components A and B. The concentration of phenolic antioxidant to use in any one of Components A and B can be calculated from the mixing ratio of A:B and the desired final concentration in the mixed adhesive.

In a preferred embodiment, the at least one phenolic antioxidant is present in in Component A only or Component B only, at 2 to 6 wt %, more preferably 4 wt %, based on the total weight of Component A or Component B, such that when Components A and B are mixed in a 1:1 ratio, the concentration of phenolic antioxidant in the final mixed adhesive is 1 to 3 wt %, more preferably 2 wt %, based on the total weight of the mixed adhesive.

In a particularly preferred embodiment, 4,6-bis(octylthiomethyl)-o-cresol is used in Component A and/or Component B in an amount to yield a final concentration in the mixed adhesive of 1 to 3 wt %, more preferably 2 wt %, based on the total weight of the mixed adhesive.

In a particularly preferred embodiment, the final mixed adhesive resulting from mixing Components A and B comprises CaO and a phenolic antioxidant, particularly a hindered phenol antioxidant. Particularly preferably, the final mixed adhesive resulting from mixing Components A and B comprises 2 to 4.5 wt %, more preferably 3.5 wt % CaO, and 1 to 3 wt %, more preferably 2 wt % phenolic antioxidant, based on the total weight of the mixed adhesive.

In another preferred embodiment, the final mixed adhesive resulting from mixing Components A and B comprises 2 to 4.5 wt %, more preferably 3.5 wt % CaO, and 1 to 3 wt %, more preferably 2 wt % 4,6-bis(octylthiomethyl)-o-cresol, based on the total weight of the mixed adhesive. In a particularly preferred embodiment, the final mixed adhesive resulting from mixing Components A and B comprises 2 to 4.5 wt % CaO and 1 to 3 wt % 4,6-bis(octylthiomethyl)-o-cresol.

In a preferred embodiment, the invention provides a two-component polyurethane adhesive composition comprising:
(A) Component A comprising a polyurethane prepolymer made by reacting at least one polyisocyanate and at least one polyol (resulting in Intermediate I), followed by reaction with a molecule of Formula I:

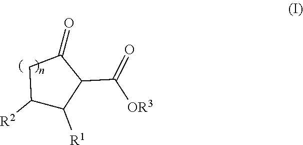

where R¹ and R² are independently selected from hydrogen and C₁ to C₆ alkyl, n is an integer from 1 to 2, and R³ is C₁ to C₆ alkyl;
and optionally a catalyst capable of catalyzing the reaction of an amine with the moiety resulting from the molecule of Formula I, and optionally CaO, and optionally a phenolic antioxidant; AND
(B) Component B comprising a polyamine, and optionally a catalyst capable of catalyzing the reaction of an amine with the moiety resulting from the molecule of Formula I, and optionally CaO, and optionally a phenolic antioxidant;
wherein at least one of Component A and Component B comprises the catalyst capable of catalyzing the reaction of an amine with the moiety resulting from the molecule of Formula I, at least one of Component A and Component B comprises CaO, and at least one of Component A and B comprises a phenolic antioxidant. Preferably the two-component polyurethane adhesive composition has an NCO content of less than 0.1 wt % as determined according to ASTM D2572-97

### Method for Making the Polyurethane Prepolymer

The invention provides a method for manufacturing a polyurethane prepolymer, comprising the steps:
(1) reacting at least one polyisocyanate and at least one polyol to produce an Intermediate I;
(2) with a molecule of Formula I:

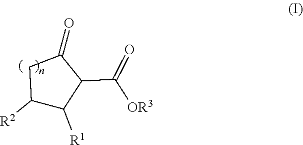

where R¹ and R² are independently selected from hydrogen and C₁ to C₆ alkyl, n is an integer from 1 to 2, and R³ is C₁ to C₆ alkyl;
wherein preferably the molecule of Formula I is used in sufficient quantity to react with all NCO groups of Intermediate I and with residual monomeric polyisocyanate, resulting in an NCO content of less than 0.1 wt %, as determined according to ASTM D2572-97.

The amount of molecule of Formula I to be used can be calculated from the NCO content of the Intermediate I, as determined according to ASTM D2572-97. Alternatively, the amount to be added can be calculated theoretically based on the amount of polyisocyanate used to make Intermediate I. In a preferred embodiment, the molecule of Formula I is used at 1.2 to 1.3 equivalents with respect to the NCO content of the molecule of Formula I (both free NCO and NCO in the molecule of Intermediate I.

In particular when it is desired to keep the molecular weight of Intermediate I (and the polyurethane prepolymer made from it) low, an excess of polyisocyanate with respect to the polyol may be used. Using conventional technology, this results in residual monomeric polyisocyanate (NCO) in the prepolymer. The conventional way to remove monomeric NCO is by distillation, which is time- and energy-consuming, and is not practical with prepolymers of elevated molecular weight.

The method of the invention essentially removes NCO groups in the polyurethane prepolymer and residual monomeric NCO groups by reacting them with the molecule of Formula I. This allows one to avoid distillation of the prepolymer.

In a preferred embodiment of the method of the invention, polyisocyanate is used in an amount of 1.2 or greater equivalents with respect to polyol to produce Intermediate I.

An example of a method for manufacturing the polyurethane prepolymer comprises the following steps:
1. the at least one polyol is stirred under an inert atmosphere (e.g. nitrogen or argon), or under vacuum, optionally in the presence of a plasticizer (e.g. diisononyl phthalate);
2. the at least one polyisocyanate is added;
3. the catalyst is added, resulting in Intermediate I;
4. once the desired NCO content is reached, the molecule of Formula I is added, preferably in an amount sufficient to react with all the NCO groups of Intermediate I and residual monomeric NCO.

A preferred embodiment of the method, comprises the following steps:
1. the at least one polyol is stirred under an inert atmosphere (e.g. nitrogen or argon), optionally in the presence of a plasticizer (e.g. diisononyl phthalate);
2. the at least one polyisocyanate is added in a ratio NCO:OH of from 1.5:1, 2:1, 4:1, 5:1 or higher;
3. the catalyst is added, resulting in Intermediate I;
4. once the desired NCO content is reached, the molecule of Formula I is added, preferably in a ratio NCO:Formula I of from 1.2 to 1.5, preferably 1.2 to 1.3.

In a preferred embodiment, the method of manufacture of the polyurethane prepolymer comprises the following steps:
1. the at least one polyol is stirred under an inert atmosphere (e.g. nitrogen or argon), or vacuum, optionally in the presence of a plasticizer (e.g. diisononyl phthalate), and heated to 65-150° C., followed by cooling to 60-80° C.;
2. the at least one polyisocyanate is added;
3. the catalyst is added, and the mixture is allowed to react at 60-100° C.;
4. once the desired NCO content is reached, the mixture of step 3 is cooled to 50-70° C. and the molecule of Formula I is added, preferably in a ratio NCO:Formula I of from 1.2 to 1.5, more preferably 1.2 to 1.3.

### Optional Ingredients

The adhesive compositions of the invention may optionally comprise a plasticizer, which may be present in Component A or B or both. Examples of plasticizers are esters, in particular diesters and triesters, particularly those having vapour pressures of <10⁻⁴ hPa at 23° C. Examples include dialkyl phthalate esters, alkyl esters of fatty acids, phosphate esters (such as trioctyl phosphate). Diisononylphthalate is particularly preferred. If used, the plasticizer is typically present at 10 to 20 wt %, preferably 12 to 18 wt %, based on the total weight of the adhesive composition. In a particularly preferred embodiment, diisononylphthalate is used at 12 to 18 wt %, more preferably at 16-17 wt %, based on the total weight of the adhesive composition.

The adhesive compositions of the invention may optionally comprise fillers, which may be present in Component A or B or both, such as carbon black, clay, carbonates (e.g. calcium carbonate), metal hydrates and fumed silica. The fillers are preferably used at from 0-80% preferably 10-70, more preferably 20-60 w %.

In a preferred embodiment, the adhesives of the invention comprise clay as filler, preferably kaolin, in particular calcined kaolin. If used, clay is used at 5 to 15 wt %, more preferably 8 to 12 wt %, based on the total weight of the adhesive composition. In a particularly preferred embodiment, kaolin is used at 8 to 12 wt %, more preferably at 9 wt %, based on the total weight of the adhesive composition.

In a preferred embodiment, the adhesives of the invention comprise carbon black as filler. The carbon black is not particularly limited. Preferred carbon blacks exhibit an oil absorption number of at least 80, preferably at least 90 and more preferably at least 95 cm³ of dibutyl phthalate per 100 g of carbon black, as measured according to ASTM D-2414-09. In addition, the carbon black desirably has an iodine number of at least 80, determined according to ASTM D1510-11.

If used, carbon black is used at 5-30 wt %, more preferably 15 to 25 wt %, based on the total weight of the adhesive composition. In a particularly preferred embodiment, carbon black is used at 15 to 25 wt %, preferably 22 to 23 wt %, based on the total weight of the adhesive composition.

The adhesive compositions of the invention may optionally comprise calcium carbonate at 0-20 wt %, more preferably 5 to 15 wt %, particularly preferably 9-10 wt %, based on the total weight of the adhesive composition. The calcium carbonate particles may be untreated or surface modified by treatment with chemicals, such as organic acids or esters of organic acids.

The adhesive compositions of the invention may optionally comprise fumed silica at 0-1.5 wt %, more preferably 0.5 to 1 wt %, based on the total weight of the adhesive.

If fumed silica is used, the particles may be untreated or surface modified by treatment with chemicals, such as chlorosilane, dichlorosilane, alkyltrialkoxysilane or polydimethylsiloxane.

The adhesive composition of the invention may optionally comprise talc, which may be present in Component A or B or both. In a preferred embodiment, talc is used in Component B at 25 to 40 wt %, more preferably 30 to 35 wt %, based on the total weight of Component B.

The adhesive composition of the invention may optionally comprise adhesion promoters, which may be present in Component A or B or both. Suitable adhesion promoters include silanes, such as Gamma-Glycidoxypropyltrimethoxysilane. In a preferred embodiment, Gamma-Glycidoxypropyltrimethoxysilane is used in Component B, at 0.5 to 2 wt %, preferably 1 wt %, based on the total weight of Component B.

The adhesive compositions of the invention may optionally comprise flame-retardants and synergists. Examples of suitable flame-retardants and synergists include:
1. aluminium, zinc and titanium salts of diethylphosphinate, in particular aluminium diethylphosphinate;
2. nitrogen and/or phosphorus containing molecules, such as melamine polyphosphate, melamine pyrophosphate, melamine cyanurate;
3. aluminium and/or zinc phosphites

A preferred combination of flame-retardants/synergists is aluminium diethylphosphinate plus melamine polyphosphate.

The adhesive compositions of the invention may optionally comprise one or more additional stabilizers, for example heat, visible light and UV-stabilizers.

Examples of heat stabilizers include alkyl substituted phenols, phosphites, sebacates and cinnamates. If present, a preferred heat stabilizer is an organophosphite and more specifically trisnonylphenyl phosphite as disclosed in U.S. Pat. No. 6,512,033, incorporated herein by reference. The heat stabilizer may constitute at least 0.01 or at least 0.3 weight percent based on the entire weight of the adhesive composition, up to at most 5 weight percent, up to 2 weight percent or up to 1.0 weight percent. The adhesive composition may be devoid of such a heat stabilizer.

For UV light stabilizers, they include benzophenones and benzotriazoles. Specific UV light absorbers include those from BASF such as TINUVIN™ P, TINUVIN™ 326, TINUVIN™ 213, TINUVIN™ 327, TINUVIN™ 571, TINUVIN™ 328, and from Cytec such as CYASORB™ UV-9, CYASORB™ UV-24, CYASORB™ UV-1164, CYASORB™ UV-2337, CYASORB™ UV-2908, CYASORB™ UV-5337, CYASORB™ UV-531, and CYASORB™ UV-3638. Among these, TINUVIN™ 571 is preferred. One or more UV light absorbers may constitute at least 0.1 weight percent, at least 0.2 weight percent or at least 0.3 parts by weight of the weight of the adhesive composition, and may constitute up to 3 weight percent, up to 2 weight percent or up to 1 weight percent thereof.

The adhesive composition of the invention may further include one or more visible light stabilizers. Preferred visible light stabilizers included hindered amine visible light stabilizers such as TINUVIN™ 144, TINUVIN™ 622, TINUVIN™ 77, TINUVIN™ 123, TINUVIN™ 765, CHIMASSORB™ 944 available from Cytec; CYASORB™ UV-500, CYASORB™ UV-3581, CYASORB™ UV-3346, all available from Ciba-Geigy. Among these, TINUVIN™ 765 is preferred choice. The visible light stabilizer(s) may constitute at least 0.1 weight percent, at least 0.2 weight percent or at least 0.3 weight percent of the adhesive composition, and may constitute up to 3 weight percent, up to 2 weight percent or up to 1.5 weight percent thereof.

### Method of Manufacture

The adhesive compositions of the invention are made by mixing the ingredients of each Component separately, preferably under inert and dry conditions and/or under vacuum, until a homogenous mixture is obtained. Once Component A and B are mixed, they are stored in separate containers until use.

### Method of Use

In one aspect, the invention provides a method for adhering a first substrate and a second substrate, comprising the steps:
(1) mixing the Components A and B of an adhesive composition of the invention to obtain a mixture;
(2) applying the mixture to the first substrate, the second substrate or both;
(3) bringing the first substrate and the second substrate into adhesive contact;
(4) allowing the mixture to cure.

As mentioned above, a preferred way of providing Components the adhesive of the invention is in airtight containers, such as airtight sealed tubes. The containers are opened immediately prior to use.

The adhesive composition of the invention may be applied by any application method, manually or with robotic equipment, including, for example, by spreading, application through a nozzle.

In a preferred embodiment one or both of the first and second substrates are selected from metal, glass, glass with primer, glass with enamel coating, plastic (e.g. polypropylene, for example with talc or glass fiber), polycarbonate, sheet molded compounds, composites (e.g. carbon fiber reinforced epoxy, glass fibre reinforced polyamide). In a preferred embodiment, at least one of the first and second substrates is metal, in particular steel or aluminium, particularly preferably e-coated steel, e-coated aluminium. In a particularly preferred embodiment, both substrates are steel.

Curing begins as soon as Components A and B are mixed. Typical curing conditions are 3 to 7 days at 23° C.

### Effect of the Invention

In certain embodiments, the adhesive compositions of the invention have an NCO content, both monomeric contaminant and in the adhesive molecules of less than 0.1 wt %, more preferably 0 wt %, as determined according to ASTM D2572-97.

The adhesive compositions of the invention show improved adhesive properties and retention of mechanical and adhesive properties after heat and weathering resistance, as compared to those that do not contain CaO.

The adhesives of the invention, after curing for 7 days at room temperature (RT), preferably show an E-modulus of 2 MPa or greater, when tested according to ISO 527-1 please apply for all below, more preferably at least 2.5 MPa.

The adhesive compositions of the invention, after curing for 7 days at RT, and heat treatment at 80° C. for one month, preferably show an E-modulus of 2 MPa or greater, when tested according to ISO 527-1, more preferably at least 2.5 MPa.

The adhesive compositions of the invention, after curing for 7 days at RT, and weathering for one month as described in the Examples, preferably show an E-modulus of 10 MPa or greater, when tested according to ISO 527-1, more preferably at least 12 MPa.

The adhesives of the invention, after curing for 7 days at room temperature (RT), preferably show tensile strength of 2.6 MPa or greater, when tested according to ISO 527-1, more preferably at least 2.7 MPa.

The adhesive compositions of the invention, after curing for 7 days at RT, and heat treatment at 80° C. for one month, preferably show tensile strength of 2.5 MPa or greater, when tested according to ISO 527-1, more preferably at least 2.7 MPa.

The adhesive compositions of the invention, after curing for 7 days at RT, and weathering for one month as described in the Examples, preferably show tensile strength of 6 MPa or greater, when tested according to ISO 527-1, more preferably at least 6.5 MPa.

The adhesive compositions of the invention that comprise CaO and at least one phenolic antioxidant show improved adhesive properties and retention of mechanical and adhesive properties after heat and weathering resistance, as compared to those that do not contain CaO and at least one phenolic antioxidant.

The adhesives of the invention that contain CaO and at least one phenolic antioxidant, after curing for 7 days at room temperature (RT), preferably show an E-modulus of 2.3 MPa or greater, when tested according to ISO 527-1, more preferably at least 2.6 MPa.

The adhesive compositions of the invention that comprise CaO and at least one phenolic antioxidant, after curing for 7 days at RT, and heat treatment at 80° C. for one month, preferably show an E-modulus of 3 MPa or greater, when tested according to ISO 527-1, more preferably at least 4 MPa.

The adhesive compositions of the invention that comprise CaO and at least one phenolic antioxidant, after curing for 7 days at RT, and weathering for one month as described in the Examples, preferably show an E-modulus of 11 MPa or greater, when tested according to ISO 527-1, more preferably at least 13 MPa.

The adhesives of the invention that contain CaO and at least one phenolic antioxidant, after curing for 7 days at room temperature (RT), preferably show tensile strength of 2.7 MPa or greater, when tested according to ISO 527-1, more preferably at least 2.8 MPa.

The adhesive compositions of the invention that comprise CaO and at least one phenolic antioxidant, after curing for 7 days at RT, and heat treatment at 80° C. for one month, preferably show tensile strength of 2.7 MPa or greater, when tested according to ISO 527-1, more preferably at least 3 MPa.

The adhesive compositions of the invention that comprise CaO and at least one phenolic antioxidant, after curing for 7 days at RT, and weathering for one month as described in the Examples, preferably show tensile strength of 6.5 MPa or greater, when tested according to ISO 527-1, more preferably at least 7 MPa.

Using the lap shear adhesion test described in the Examples, the adhesives of the invention, after curing for 7 days at room temperature (RT), preferably have a lap shear strength of 2 MPa or greater, more preferably at least 2.3 MPa, and show a failure mode of 100% cohesive failure.

Using the lap shear adhesion test described in the Examples, the adhesives of the invention, after curing for 1 month at room temperature (RT), preferably have a lap shear strength of 2 MPa or greater, more preferably at least 2.5 MPa, and show a failure mode of 100% cohesive failure.

### Particularly Preferred Embodiments

The following are particularly preferred embodiments of the adhesive compositions of the invention:
1. A two-component polyurethane adhesive composition comprising:
   (A) Component A comprising a polyurethane prepolymer made by reacting at least one polyisocyanate and at least one polyol (resulting in Intermediate I), followed by reaction with a molecule of Formula I:

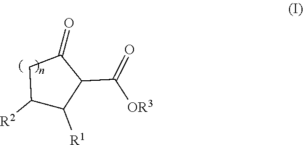

where R¹ and R² are independently selected from hydrogen and C₁ to C₆ alkyl, n is an integer from 1 to 2, and R³ is C₁ to C₆ alkyl;
and optionally a catalyst capable of catalyzing the reaction of an amine with the moiety resulting from the molecule of Formula I, and optionally CaO; AND
(B) Component B comprising a polyamine, and optionally a catalyst capable of catalyzing the reaction of an amine with the moiety resulting from the molecule of Formula I, and optionally CaO;
wherein at least one of Component A and Component B comprises the catalyst capable of catalyzing the reaction of an amine with the moiety resulting from the molecule of Formula I, and at least one of Component A and Component B comprises CaO.
2. A two-component polyurethane adhesive composition comprising:
   (A) Component A comprising a polyurethane prepolymer made by reacting at least one polyisocyanate and at least one polyol (resulting in Intermediate I), followed by reaction with a molecule of Formula I:

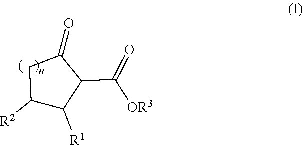

where R¹ and R² are independently selected from hydrogen and C₁ to C₆ alkyl, n is an integer from 1 to 2, and R³ is C₁ to C₆ alkyl;
and optionally a catalyst capable of catalyzing the reaction of an amine with the moiety resulting from the molecule of Formula I, and optionally CaO, and optionally a phenolic antioxidant; AND
(B) Component B comprising a polyamine, and optionally a catalyst capable of catalyzing the reaction of an amine with the moiety resulting from the molecule of Formula I, and optionally CaO, and optionally a phenolic antioxidant;
wherein at least one of Component A and Component B comprises the catalyst capable of catalyzing the reaction of an amine with the moiety resulting from the molecule of Formula I, at least one of Component A and Component B comprises CaO, and at least one of Component A and B comprises a phenolic antioxidant.
3. Any one preceding embodiment, wherein the at least one polyol is selected from polyether polyols, polyester polyols (e.g. polycaprolactone), polybutadiene diols, polycarbonate diols, aliphatic diols (polyols), and mixtures of any of these.
4. Any one preceding embodiment, wherein the at least one polyol is a polyether polyol.
5. Any one preceding embodiment, wherein the at least one polyol is a diol, triol or tetra-ol.
6. Any one preceding embodiment, wherein the at least one polyol is a triol.
7. Any one preceding embodiment, wherein the at least one polyol is selected from polyoxyethylene, polyoxypropylene, polyoxybutylene, and polytetramethylene ether diols and triols, and mixtures of these.
8. Any one preceding embodiment, wherein the at least one polyol is a polyoxypropylene ether triol.
9. Any one preceding embodiment, wherein the at least one polyol is a polyoxypropylene ether diol.
10. Any one preceding embodiment, wherein the at least one polyol has a molecular weight of 1,500-3,000 Da.
11. Any one preceding embodiment, wherein the at least one polyol is a polyoxypropylene ether diol having a molecular weight of 1,500-3,000 Da.
12. Any one preceding embodiment, wherein the at least one polyisocyanate is a diisocyanate or a triisocyanate.
13. Any one preceding embodiment, wherein the at least one polyisocyanate is selected from toluene diisocyanate (TDI), hexamethylene diisocyanate (HDI), naphthalene diisocyanate (NDI), methylene bis-cyclohexylisocyanate (HMDI), methylenebis(phenyl isocyanate) (MDI, in particular 4,4′- and 4,2-MDI) and isophorone diisocyanate (IPDI).
14. Any one preceding claim, wherein the at least one polyisocyanate is HDI.
15. Any one preceding embodiment, wherein the at least one polyisocyanate is used at 1.2 equivalents or greater with respect to the at least one polyol.
16. Any one preceding embodiment, wherein in the molecule of Formula I, R¹ and R² are independently selected from H and C₁ to C₄ alkyl.
17. Any one preceding embodiment, wherein in the molecule of Formula I, R¹ and R² are independently selected from H and C₁ to C₂ alkyl.
18. Any one preceding embodiment, wherein in the molecule of Formula I, R¹ and R² are H.
19. Any one preceding embodiment, wherein in the molecule of Formula I, n is 1.
20. Any one preceding embodiment, wherein in the molecule of Formula I, R³ is C₁ to C₄ alkyl.
21. Any one preceding embodiment, wherein in the molecule of Formula I, R³ is C₁ to C₂ alkyl.
22. Any one preceding embodiment, wherein in the molecule of Formula I, R³ is ethyl.
23. Any one preceding embodiment, wherein in the molecule of Formula I, R¹ and R² are H, n is 1, and R³ is ethyl [2-(ethoxycarbonyl)cyclopentanone, CPEE]

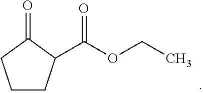

24. Any one preceding embodiment, wherein the molecule of Formula I is used in an amount that is sufficient to react with all NCO groups of Intermediate I.
25. Any one preceding embodiment, wherein the molecule of Formula I is used in an amount that is sufficient to react with all the NCO groups of Intermediate I and any residual monomeric isocyanate.
26. Any one preceding embodiment, wherein the at least one polyol and the at least one polyisocyanate are reacted in the presence of a catalyst that comprises a zinc carboxylate.
27. Any one preceding embodiment, wherein Intermediate I and the molecule of Formula I are reacted in the presence of a catalyst that comprises a zinc carboxylate.
28. Any one preceding embodiment, wherein the at least one polyamine in Component B is a diamine, a triamine or a mixture of these.
29. Any one preceding claim, wherein the at least one polyamine is a triamine.
30. Any one preceding embodiment, wherein the at least one polyamine has a molecular weight of at least 400 Da.
31. Any one preceding embodiment, wherein the at least one polyamine has a molecular weight of at least 1,000 Da.
32. Any one preceding embodiment, wherein the at least one polyamine has a molecular weight of at least 2,000 Da.
33. Any one preceding embodiment, wherein the at least one polyamine has a molecular weight of 2,000-4,000 Da.
34. Any one preceding embodiment, wherein the at least one polyamine has a molecular weight of at or about 3,000 Da.
35. Any one preceding embodiment, wherein the at least one polyamine has primary amine groups.
36. Any one preceding embodiment, wherein the at least one polyamine is selected from polyoxyalkylene polyamines having 2 or more amine groups per polyamine.
37. Any one preceding embodiment, wherein the at least one polyamine is selected from polyoxyalkylene polyamines having 3 amine groups per polyamine.
38. Any one preceding embodiment, wherein the at least one polyamine is selected from polyoxyalkylene polyamines having 3 amine groups per polyamine, and a molecular weight of 2,000 to 4,000 Da.
39. Any one preceding embodiment, wherein the at least one polyamine is selected from polyamines having a propylene oxide polyether backbone.
40. Any one preceding embodiment, wherein the at least one polyamine is selected from:
   trifunctional primary amines having an average molecular weight of approximately 440, of the general formula:

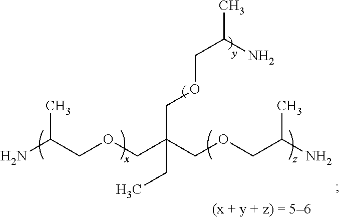

a polypropylene oxide diamine having a molecular weight of about 400:

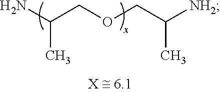

a difunctional, primary amine with average molecular weight of about 2000 of the following general formula:

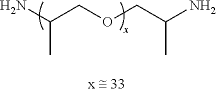

a triamine of approximately 3000 molecular weight, of the general formula:

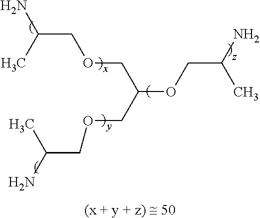

a triamine of approximately 5,000 g/mol, of the general formula:

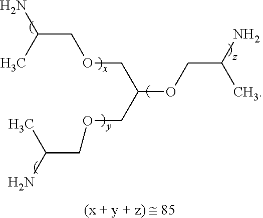

41. Any one preceding embodiment, wherein the at least one polyamine is a triamine of approximately 3,000 g/mol, of the general formula:

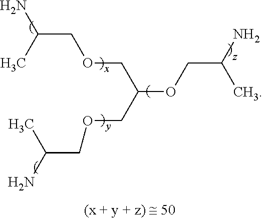

42. Any one preceding embodiment, comprising CaO in Component A and/or Component B in an amount to yield a concentration in a mixture of Component A and Component B of 2 to 6 wt %, based on the total weight of Components A and B.
43. Any one preceding embodiment, comprising CaO in Component A and/or Component B in an amount to yield a concentration in a mixture of Component A and Component B of 3 to 5 wt %, based on the total weight of Components A and B.
44. Any one preceding embodiment, wherein Component A and/or Component B comprises at least one phenolic antioxidant.
45. Any one preceding embodiment, wherein Component A and/or Component B comprises at least one hindered phenolic antioxidant.
46. Any one preceding embodiment, wherein Component A and/or Component B comprises at least one hindered phenolic antioxidant selected from 4,6-bis(octylthiomethyl)-o-cresol (Irganox 1520L), pentaerythritol tetrakis[3-[3,5-di-tert-butyl-4-hydroxyphenyl]propionate (Irganox 1010), octadecyl-3-[3,5-di-tert-butyl-4-hydroxyphenyl]propionate] (Irganox 1076), N,N′-hexane-1,6-diylbis(3-(3,5-di-tert-butyl-4-hydroxyphenylpropionamide)) (Irganox 1098), 3,3′,3′,5,5′,5′-hexa-tert-butyl-a,a′,a′-(mesitylene-2,4,6-triyl)tri-p-cresol (Irganox 1330), 1,3,5-tris(3,5-di-tert-butyl-4-hydroxybenzyl)-1,3,5-triazine-2,4,6(1H,3H,5H)-trione (Irganox 3114), ethylene bis (oxyethylene) bis-(3-(5-tert-butyl-4-hydroxy-m-tolyl)-propionate) (Irganox 245), benzenepropanoic acid, 3,5-bis (1,1-dimethyl-ethyl)-4-hydroxy-C₇-C₉ branched alkyl esters (Irganox 1135), 3,5-Di-tert-butyl-4-hydroxcinnamic acid (Irganox 3125), hexamethylene bis(3-(3,5-di-tert.-butyl-4-hydroxyphenyl)propionate) (Irganox 259), Thiodiethylene bis[3-(3,5-di-tert.-butyl-4-hydroxy-phenyl)propionate] (Irganox 1035), and mixtures of these.
47. Any one preceding embodiment, wherein Component A and/or Component B comprises at least one hindered phenolic antioxidant which is 4,6-bis(octylthiomethyl)-o-cresol (Irganox 1520L),
48. Any one preceding embodiment, comprising at least one phenolic antioxidant in Component A and/or Component B in an amount to yield a concentration in a mixture of Component A and Component B of 0.5 to 6 wt %, based on the total weight of Components A and B.
49. Any one preceding embodiment, comprising at least one phenolic antioxidant in Component A and/or Component B in an amount to yield a concentration in a mixture of Component A and Component B of 1 to 3 wt %, based on the total weight of Components A and B.
50. Any one preceding embodiment, wherein Component A and/or Component B comprise Cao and 4,6-bis(octylthiomethyl)-o-cresol (Irganox 1520L), in amounts to yield to yield a concentration of CaO in a mixture of Component A and Component B of 3 to 5 wt %, and a concentration of 4,6-bis(octylthiomethyl)-o-cresol (Irganox 1520L) in a mixture of Component A and B of 1 to 3 wt %, based on the total weight of Components A and B.
51. Any one preceding embodiment, wherein Component A and/or Component B additionally comprise a plasticizer.
52. Any one preceding embodiment, wherein Component A and/or Component B additionally comprise a plasticizer which is diisononyl phthalate.
53. Any one preceding embodiment, wherein Component A and/or Component B additionally comprise an adhesion promoter.
54. Any one preceding embodiment, wherein Component A and/or Component B additionally comprise an adhesion promoter which is a silane.
55. Any one preceding embodiment, wherein Component A and/or Component B additionally comprise an adhesion promoter which is Gamma-Glycidoxypropyltrimethoxysilane.
56. Any one preceding embodiment, wherein Component A comprises:
   a polyurethane prepolymer made from a propylene oxide polyether diol of molecular weight 2,000 Da, 1,6-HDI and CPEE;
   aluminium hydroxide; and
   CaO.
57. Any one preceding embodiment, wherein Component B comprises: a triamine of approximately 3,000 g/mol, of the general formula:

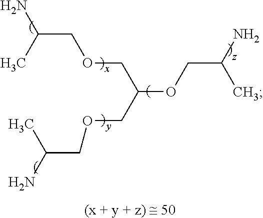

and
   a catalyst capable of catalysing the reaction of an amine with a moiety of Formula I.
58. Any one preceding embodiment, wherein Component B comprises: a triamine of approximately 3,000 g/mol, of the general formula:

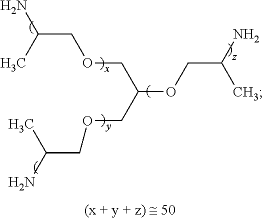

a catalyst capable of catalysing the reaction of an amine with a moiety of Formula I; and
CaO.
59. Any one preceding embodiment, wherein the molecule of Formula I is used in sufficient quantity to react with all NCO groups of Intermediate I and with residual monomeric polyisocyanate, resulting in an NCO content of less than 0.1 wt %, as determined according to ASTM D2572-97.
60. A method for adhering a first substrate and a second substrate, comprising the steps:
   (1) mixing the Components A and B of an adhesive composition of any one preceding embodiment to obtain a mixture;
   (2) applying the mixture to the first substrate, the second substrate or both;
   (3) bringing the first substrate and the second substrate into adhesive contact;
   (4) allowing the mixture to cure.
61. An adhered assembly comprising:
   (1) a first substrate;
   (2) a second substrate;
   (3) an adhesive composition obtained by mixing Component A and Component B of any one preceding embodiment;
   wherein the first and second substrates are in adhesive contact with the adhesive composition sandwiched between them.

### Examples

TABLE 1
Ingredients

| Trademark | | |
|---|---|---|
| or | | |
| abbreviation | Chemistry | Function |
| VORANOL | a polypropylene glycol, propyleneglycol initiated, 2000 | diol |
| 2000L | molecular weight homopolymer diol. | |
| Desmodur H | 1,6-HDl, 1,6-hexamethylenediisocyanate supplied by Covestro | diisocyanate |
| TIB KAT 718 | Mixture of zinc and bismuth carboxylates | catalyst |
| Jeffamine T- | Polyether-based triamine of approximately 3,000 molecular | |
| 3000 | weight with the formula: | |
| | 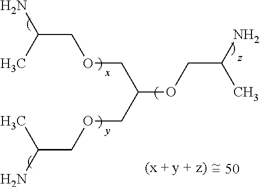 [SMILES: CC(N)COCC(COCC(C)N)OCC(C)N] | |
| CPEE | Ethyl-2-oxocyclopentanecarboxylate | |
| Apyral 44 | Aluminiumhydroxide | |
| CaO | Calcium oxide | |
| Vestinol 9 | Di-isononylphthalate | Plasticizer |
| Bicat 8108 | bismuth(3+) neodecanoate (<80%) with an excess of | catalyst |
| | neodecanoic acid (<40%). | |
| Irganox 1520 L | 4,6-Bis(octylthiomethyl)-o-cresol | Phenolic |
| | | antioxidant |
| Cinilex DPP | Diketo-pyrrolo-pyrrole dye | dye |
| red | | |
| Talc | Talc | |
| Silquest A-187 | Gamma-Glycidoxypropyltrimethoxysilane | |

### Preparation of Polyurethane Prepolymer for Component A

Blocked polyurethane Prepolymer 1 was prepared using the ingredients listed in Table 2.

TABLE 2
Composition of Prepolymer 1

| | | Prepolymer 1 |
|---|---|---|
| Ingredient | Nature | (wt %) |
| Voranol 2000L | Polyether diol | 74.57 |
| Desmodur H | 1,6-HDI | 12.57 |
| TIB KAT 718 | Mixture of zinc and bismuth | 0.50 |
| | carboxylates | |
| CPEE | Ethyl-2- | 12.36 |
| | oxocyclopentanecarboxylate | |

The Voranol 2000L was added to a lab reactor and heated to 100° C. (material temperature) under vacuum and stirring. After the material temperature reached 100° C., the material was cooled to 70° C. under N₂ and stirring. The 1,6 hexamethylene-diisocyanate was added under stirring. After the material temperature reached 60° C. the catalyst was added. The bath temperature was set to 80° C. The mixture was allowed to react for 25 min. under stirring and N₂. The CPEE was added and the mixture was allowed to react for 50 min. under stirring and N₂. The NCO content was determined to be zero. The mixture was degassed under vacuum.

### Adhesive Formulation Components A and B

The adhesive formulations Components A and B were prepared using the ingredients and amounts listed in Table 3.

TABLE 3
Ingredients in Component A and Component B

| | | Innovative | Innovative | Reference |
|---|---|---|---|---|
| | | Example 2 | Example 3 | Example 1 |
| | Component A | % | % | % |
| 1 | Prepolymer 1 | 67.00 | 67.00 | 67.00 |
| 2 | Apyral 44 | 28.00 | 28.00 | 33.00 |
| 3 | CaO | 5.00 | 5.00 | — |
| | Total | 100.00 | 100.00 | 100.00 |
| | Density [g/ml] | 1.263 | 1.263 | 1.253 |
| | Component B | % | | |
| 1 | Jeffamin T-3000 | 58.45 | 58.45 | 58.45 |
| 2 | BiCat 8108 | 0.50 | 0.50 | 0.50 |
| 3 | Vestinol 9 | 4.00 | — | 4.55 |
| 4 | Cinilex DPP red | 0.25 | 0.25 | 0.25 |
| 5 | Talc | 33.78 | 33.78 | 35.25 |
| 6 | CaO | 2.02 | 2.02 | — |
| 7 | Irganox 1520L | — | 4.00 | — |
| 8 | Silquest A-187 | 1.00 | 1.00 | 1.00 |
| | Total | 100.00 | 100.00 | 100.00 |
| | Density [g/ml] | 1.261 | 1.262 | 1.253 |

Component A was made by adding the ingredients 1-3 to a lab mixer and mixing for 10 min with 120 rpm at RT. The mixture was removed with a spatula from the stirrers. It was mixed for another 15 min under vacuum at 120 rpm and RT.

Component B was made by adding the ingredients 1-7 to a lab mixer and mixing for 10 min with 120 rpm at RT. The mixture was removed with a spatula from the stirrers. Component 8 was added and the mixture was mixed for another 15 min under vacuum at 120 rpm and RT.

### Mixing

Bulk adhesive samples were distributed out of double-sided cartridge and applied through a cartridge gun in a ratio of Component A to Component B of 1:1.

### Tests

### Viscosity

Viscosity was measured on a Kinexus rheometer using a plate/cone set-up with a 20 mm diameter cone with 4° angle and a gap of 0.144 mm. The measurement was performed at 23° C. A shear-rate measurement was performed from 0.1 to 10 1/s and the Newtonian viscosity is reported.

### Lap Shear Tests

Lap shear tests were performed according to DIN EN 1465 with e-coated (Cathoguard) steel substrates (DC04ZE50) with a thickness of 1 mm. The adhesive composition was applied and the second substrate was joined. The adhesive overlap area was 25×10 mm, adhesive thickness was 0.5 mm. Lap shear tests were performed after curing of the adhesive composition for 7 days at RT. The tests were performed on a Zwick tensiometer with a 5 kN force measurement system, with 2 N preload, and 10 mm/min pulling speed. The tests were performed at 23° C. Results are shown in Table 7 (immediately after curing) and Table 8 (after 1 month at 23° C.).

Reference 1 shows lower lap shear strength immediately after curing than Examples 2 and 3 (Table 7), and also after storage at room temperature for 1 month (Table 8).

### Tensile Tests

Tensile tests were performed according to ISO 527-1. Dogbones were cut from a 2 mm thick plate that was cured for at least 7 days at 23° C. Preload was 1 N, sample width 4 mm, pulling speed was 200 mm/min. A 500 N force measurement system was used with a MuliXtens distance measurement system. Results are listed in Table 4 (immediately after curing), Table 5 (after 1 month at 80° C.) and Table 6 (after weather cycling for 1 month).

The tensile strength of Reference 1 shows a significant drop after storage at elevated temperature (80° C.), whereas Examples 2 and 3 essentially retain the tensile strength measured immediately after curing.

The tensile strength of Reference 1 drops dramatically after weather cycling for 1 month, whereas Examples 2 and 3 actually increase in tensile strength.

### Elongation at Break

Elongation at beak was measured according to ISO 527-1.

Results are shown in Table 7 (immediately after curing) and Table 8 (after 1 month at 23° C.).

### Weather Cycling

Samples were subjected to the following twelve-hour cycles:
60 minutes heat up to 80° C. and 80% relative humidity (RH);
240 minutes at 80° C. and 80% RH;
120 minutes cool down to −40° C.;
240 minutes at 40° C.;
60 minutes heat up to 23° C.;
Storage at 80° C.

### Molecular Weight

Molecular Weight data of the polyurethane prepolymers were measured by gel permeation chromatography (GPC) with a Malvern Viscothek GPC max equipment. Tetrahydrofuran (THF) was used as an eluent, PL GEL MIXED D (Agilent, 300*7.5 mm, 5 μm) was used as a column, and MALVERN Viscotek TDA (integrated refractive index viscometer and light scattering) was used as a detector.

### Thermal Degradation Under Inert Atmosphere

Equipment: TGA 5500 from TA

Thermal degradation of the cured adhesives under an inert atmosphere (N₂) was measured using thermogravimetric analysis from 40-600° C., for 30 minutes. Degradation was measured after curing for 1 day at RT, immediately after curing and after 1 month at 80° C., 3 months at 80° C., 1 month weather cycling and 3 months weather cycling. The results are listed in Table 9.

The lower the temperature of degradation onset, the less stable the adhesive. The results in Table 9 show that Reference 1 is significantly less stable after storage at elevated temperature (80° C.) for one and three months, and particularly after weather cycling for one and three months.

### Thermal Oxidative Degradation Under O₂ Atmosphere

Thermal degradation of the cured adhesives under an O₂ atmosphere was measured using thermogravimetric analysis. From 40-600° C. for 30 minutes. Degradation was measured after curing for 1 day at RT, immediately after curing and after 1 month at 80° C., 3 months at 80° C., 1 month weather cycling and 3 months weather cycling. The results are listed in Table 10.

The lower the temperature of degradation onset, the less stable the adhesive. The results in Table 10 show that Reference 1 is significantly less stable after storage at elevated temperature (80° C.) for one and three months, and particularly after weather cycling for one and three months.

### NCO Content

NCO measurements were performed according to ASTM D2572-97. This test method is applicable for liquids containing isocyanates. There are included monomers (e.g. methylendiphenyldiisocyanate MDI), prepolymers and adhesive formulations. The isocyanate (NCO) sample reacts with an excess of dibutylamine to form the corresponding urea. The NCO content was determined from the amount of dibutylamine consumed in the reaction. The result is reported as percent NCO (weight percent).

Alternatively, infrared spectroscopy was used to look for the NCO band at 2268 cm-1. Equipment: Agilent Technologies CARY 600

The adhesives of the invention showed essentially 0 wt % NCO in the polymer and 0 wt % free isocyanate.

TABLE 4
Tensile properties after curing at 23° C.
for 7 days of inventive and comparative adhesives

| | E- | Tensile | elongation | Force | Force | Force |
|---|---|---|---|---|---|---|
| | Modul | strength | at break | @100% | @200% | @400% |
| 7 d RT | [MPa] | [MPa] | [%] | [MPa] | [MPa] | [MPa] |
| Example 2 | 2.7 | 2.9 | 314 | 1.5 | 2.3 | — |
| Example 3 | 2.8 | 2.9 | 311 | 1.5 | 2.2 | — |
| Reference 1 | 1.3 | 2.7 | 484 | 0.8 | 1.5 | 2.4 |

TABLE 5
Tensile properties of inventive and comparative adhesives (curing at 23°
C. for 7 days) followed by storage at 80° C. for 1 month

| 7 d RT + | E- | Tensile | elongation | Force | Force | Force |
|---|---|---|---|---|---|---|
| 1 m 80° C. | Modul | strength | at break | @100% | @200% | @400% |
| storage | [MPa] | [MPa] | [%] | [MPa] | [MPa] | [MPa] |
| Example 2 | 2.5 | 2.7 | 285 | 1.5 | 2.3 | — |
| Example 3 | 4.1 | 3.2 | 188 | 3.4 | — | — |
| Reference 1 | 1.5 | 1.6 | 222 | 0.9 | — | — |

TABLE 6
Tensile properties of inventive and comparative adhesives (curing
at 23° C. for 7 days) followed by weather cycling for 1 month

| | | | elonga- | | | |
|---|---|---|---|---|---|---|
| 7 d RT + | E- | Tensile | tion | | F | F |
| 1 m weather | Modul | strength | at break | F@100% | @200% | @400% |
| cycling | [MPa] | [MPa] | [%] | [MPa] | [MPa] | [MPa] |
| Example 2 | 12.7 | 6.7 | 153 | 6.5 | — | — |
| Example 3 | 14.5 | 7.3 | 266 | 6.4 | — | — |
| Reference 1 | 0.5 | 1.0 | 279 | 0.5 | 0.9 | — |

TABLE 7
Lap shear strength, elongation at break and failure mode for inventive
and comparative adhesives (curing at 23° C. for 7 days)

| | Lapshear- | elongation | |
|---|---|---|---|
| | strength | at break | failure |
| | [MPa] | [mm] | mode |
| Example 2 | 2.8 | 7.4 | CF |
| Example 3 | 2.3 | 5.0 | CF |
| Reference 1 | 1.0 | 5.3 | AF |

CF = cohesive failure
AF = adhesive failure

TABLE 8
Lap shear strength, elongation at break and failure mode
for inventive and comparative adhesives (curing at 23°
C. for 7 days) followed by storage for 1 month at 23° C.

| | Lapshear- | elongation | |
|---|---|---|---|
| | strength | at break | failure |
| | [MPa] | [mm] | mode |
| Example 2 | 2.8 | 7.7 | CF |
| Reference 1 | 0.9 | 4.8 | 20% CF |
| | | | 80% AF |

CF = cohesive failure
AF = -adhesion failure

TABLE 9
Thermal degradation under N₂ atmosphere (curing for
1 day at RT), with various heat/weather treatments

| | | | | 1 d RT + | 1 d RT + |
|---|---|---|---|---|---|
| | | 1 d RT + | 1 d RT + | 1 m weather | 3 m weather |
| | 1 d RT | 1 m 80° C. | 3 m 80° C. | cycling | cycling |
| | Onset [° C.] | Onset [° C.] | Onset [° C.] | Onset [° C.] | Onset [° C.] |
| Example 2 | 417 (*1) | 395 (*2) | 258 (*2) | 412 (*1) | 355 (*1) |
| Example 3 | 419 (*1) | 426 (*1) | 355 (*1) | 412 (*1) | 349 (*1) |
| Reference 1 | 415 (*1) | 263 (*2) | 258 (*2) | 337 (*2) | 255 (*2) |

*1 = no decomposition visible on optical inspection after storage and prior to TGA testing
*2 = decomposition visible on optical inspection after storage and prior to TGA testing

TABLE 10
Thermal degradation under O₂ atmosphere (curing
for 1 day at RT), with various treatments

| | | | | 1 d RT + | 1d RT + |
|---|---|---|---|---|---|
| | | 1 d RT + | 1 d RT + | 1 m | 3 m |
| | 1 d RT | 1 m 80° C. | 3 m 80° C. | PV1200 | PV1200 |
| | Onset [° C.] | Onset [° C.] | Onset [° C.] | Onset [° C.] | Onset [° C.] |
| Example 2 | 242 (*1) | 268 (*2) | 297 (*2) | 317 (*1) | 386 (*1) |
| Example 3 | 268 (*1) | 261 (*1) | 257 (*1) | 334 (*1) | 335 (*1) |
| Reference 1 | 216 (*1) | 248 (*2) | 243 (*2) | 208 (*2) | 243 (*2) |

*1 = no decomposition visible on optical inspection after storage and prior to TGA testing
*2 = decomposition visible on optical inspection after storage and prior to TGA testing

1. A two-component polyurethane adhesive composition comprising:
(A) Component A comprising a polyurethane prepolymer made by reacting at least one polyisocyanate and at least one polyol (resulting in Intermediate I), followed by reaction with a molecule of Formula I: 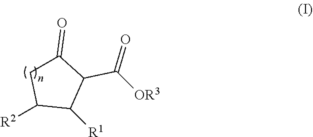
where R¹ and R² are independently selected from hydrogen and C₁ to C₆ alkyl, n is an integer from 1 to 2, and R³ is C₁ to C₆ alkyl;
and optionally a catalyst capable of catalyzing the reaction of an amine with the moiety resulting from the molecule of Formula I, and optionally CaO; AND
(B) Component B comprising a polyamine, and optionally a catalyst capable of catalyzing the reaction of an amine with the moiety resulting from the molecule of Formula I, and optionally CaO;
wherein at least one of Component A and Component B comprises the catalyst capable of catalyzing the reaction of an amine with the moiety resulting from the molecule of Formula I, and at least one of Component A and Component B comprises CaO.

2. A two-component polyurethane adhesive composition comprising:
(A) Component A comprising a polyurethane prepolymer made by reacting at least one polyisocyanate and at least one polyol (resulting in Intermediate I), followed by reaction with a molecule of Formula I: 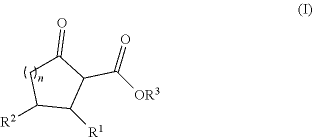
where R¹ and R² are independently selected from hydrogen and C₁ to C₆ alkyl, n is an integer from 1 to 2, and R³ is C₁ to C₆ alkyl;
and optionally a catalyst capable of catalyzing the reaction of an amine with the moiety resulting from the molecule of Formula I, and optionally CaO, and optionally a phenolic antioxidant; AND
(B) Component B comprising a polyamine, and optionally a catalyst capable of catalyzing the reaction of an amine with the moiety resulting from the molecule of Formula I, and optionally CaO, and optionally a phenolic antioxidant;
wherein at least one of Component A and Component B comprises the catalyst capable of catalyzing the reaction of an amine with the moiety resulting from the molecule of Formula I, at least one of Component A and Component B comprises CaO, and at least one of Component A and B comprises a phenolic antioxidant.

3. The adhesive composition of claim 1, wherein the at least one polyol is selected from polyether polyols, polyester polyols (e.g. polycaprolactone), polybutadiene diols, polycarbonate diols, aliphatic diols (polyols), and mixtures of any of these.

4. The adhesive composition of claim 1, wherein the at least one polyol is a polyether polyol.

5. The adhesive composition of claim 1, wherein the at least one polyol is a diol, triol or tetra-ol.

6. The adhesive composition of claim 1, wherein the at least one polyol is a triol.

7. The adhesive composition of claim 1, wherein the at least one polyol is selected from polyoxyethylene, polyoxypropylene, polyoxybutylene, and polytetramethylene ether diols and triols, and mixtures of these.

8-11. (canceled)

12. The adhesive composition of claim 1, wherein the at least one polyisocyanate is a diisocyanate or a triisocyanate.

13. The adhesive composition of claim 1, wherein the at least one polyisocyanate is selected from toluene diisocyanate (TDI), hexamethylene diisocyanate (HDI), naphthalene diisocyanate (NDI), methylene bis-cyclohexylisocyanate (HMDI), methylenebis(phenyl isocyanate) (MDI, in particular 4,4′- and 4,2-MDI) and isophorone diisocyanate (IPDI).

14. (canceled)

15. The adhesive composition of claim 1, wherein the at least one polyisocyanate is used at 1.2 equivalents or greater with respect to the at least one polyol.

16. The adhesive composition of claim 1, wherein in the molecule of Formula I, R¹ and R² are independently selected from H and C₁ to C₄ alkyl.

17-25. (canceled)

26. The adhesive composition of claim 1, wherein the at least one polyol and the at least one polyisocyanate are reacted in the presence of a catalyst that comprises a zinc carboxylate.

27. (canceled)

28. The adhesive composition of claim 1, wherein the at least one polyamine in Component B is a diamine, a triamine or a mixture of these.

29-34. (canceled)

35. The adhesive composition of claim 1, wherein the at least one polyamine has primary amine groups.

36. The adhesive composition of claim 1, wherein the at least one polyamine is selected from polyoxyalkylene polyamines having 2 or more amine groups per polyamine.

37-39. (canceled)

40. The adhesive composition of claim 1, wherein the at least one polyamine is selected from: trifunctional primary amines having an average molecular weight of approximately 440, of the general formula: 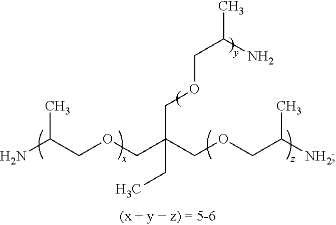
a polypropylene oxide diamine having a molecular weight of about 400: 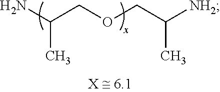
a difunctional, primary amine with average molecular weight of about 2000 of the following general formula: 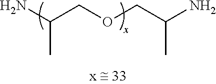
a triamine of approximately 3000 molecular weight, of the general formula: 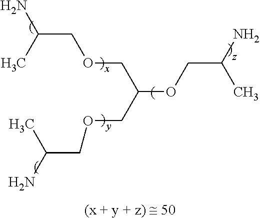
a triamine of approximately 5,000 g/mol, of the general formula:

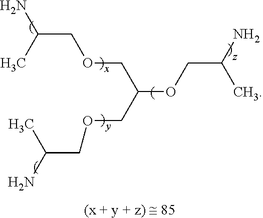

41. The adhesive composition of claim 1, wherein the at least one polyamine is a triamine of approximately 3,000 g/mol, of the general formula:

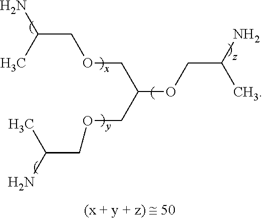

42. The adhesive composition of claim 1, comprising CaO in Component A and/or Component B in an amount to yield a concentration in a mixture of Component A and Component B of 2 to 6 wt %, based on the total weight of Components A and B.

43-45. (canceled)

46. The adhesive composition of claim 1, wherein Component A and/or Component B comprises at least one hindered phenolic antioxidant selected from 4,6-bis(octylthiomethyl)-o-cresol (Irganox 1520L), pentaerythritol tetrakis[3-[3,5-di-tert-butyl-4-hydroxyphenyl]propionate (Irganox 1010), octadecyl-3-[3,5-di-tert-butyl-4-hydroxyphenyl]propionate] (Irganox 1076), N,N′-hexane-1,6-diylbis(3-(3,5-di-tert-butyl-4-hydroxyphenylpropionamide)) (Irganox 1098), 3,3′,3′,5,5′,5′-hexa-tert-butyl-a,a′,a′-(mesitylene-2,4,6-triyl)tri-p-cresol (Irganox 1330), 1,3,5-tris(3,5-di-tert-butyl-4-hydroxybenzyl)-1,3,5-triazine-2,4,6(1H,3H,5H)-trione (Irganox 3114), ethylene bis (oxyethylene) bis-(3-(5-tert-butyl-4-hydroxy-m-tolyl)-propionate) (Irganox 245), benzenepropanoic acid, 3,5-bis (1,1-dimethyl-ethyl)-4-hydroxy-C₇-C₉ branched alkyl esters (Irganox 1135), 3,5-Di-tert-butyl-4-hydroxcinnamic acid (Irganox 3125), hexamethylene bis(3-(3,5-di-tert.-butyl-4-hydroxyphenyl)propionate) (Irganox 259), Thiodiethylene bis[3-(3,5-di-tert.-butyl-4-hydroxy-phenyl)propionate] (Irganox 1035), and mixtures of these.

47-49. (canceled)

50. The adhesive composition of claim 1, wherein Component A and/or Component B comprise Cao and 4,6-bis(octylthiomethyl)-o-cresol (Irganox 1520L), in amounts to yield to yield a concentration of CaO in a mixture of Component A and Component B of 3 to 5 wt %, and a concentration of 4,6-bis(octylthiomethyl)-o-cresol (Irganox 1520L) in a mixture of Component A and B of 1 to 3 wt %, based on the total weight of Components A and B.

51-61. (canceled)
